(19) United States
(12) Patent Application Publication
(10) Pub. No.: US 2013/0215493 A1
(43) Pub. Date: Aug. 22, 2013

(54) ELECTROPHORETIC DISPLAY FILM AND ELECTROPHORETIC DISPLAY APPARATUS

(71) Applicants: Fang-An Shu, Hsinchu (TW); Yao- Chou Tsai, Hsinchu (TW); Kuan-Yi Lin, Hsinchu (TW); Wen-Chung Tang, Hsinchu (TW)

(72) Inventors: Fang-An Shu, Hsinchu (TW); Yao- Chou Tsai, Hsinchu (TW); Kuan-Yi Lin, Hsinchu (TW); Wen-Chung Tang, Hsinchu (TW)

(73) Assignee: E INK HOLDINGS INC., Hsinchu (TW)

(21) Appl. No.: 13/437,878

(22) Filed: Apr. 2, 2012

(30) Foreign Application Priority Data
Feb. 16, 2012 (TW) 101105076

(51) Int. Cl. G02F 1/167

(52) U.S. Cl. 359/296

(57) ABSTRACT

An electrophoretic display film is provided, which includes a first protective film, a second protective film and a plurality of display media. The second protective film is opposite to the first protective film. The display media are disposed between the first protective film and the second protective film, in which each of the display media includes an electrophoretic liquid and a plurality of black charged particles and a plurality of charged particles with metallic gloss both distributed in the electrophoretic liquid.

### CROSS-REFERENCE TO RELATED APPLICATION

This application claims the priority benefit of Taiwan application serial no. 101105076, filed on Feb. 16, 2012. The entirety of the above-mentioned patent application is hereby incorporated by reference herein and made a part of this specification.

### BACKGROUND OF THE INVENTION

1. Field of the Invention

The invention generally relates to a display film and a display apparatus, and more particularly, to an electrophoretic display film and an electrophoretic display apparatus.

2. Description of Related Art

In recent years, since various display techniques continue to flourish, after ceaselessly researching and developing, many display products such as electrophoretic display, liquid crystal display (LCD), plasma display, organic light-emitting diode display (OLED display) have been gradually commercialized and applied in display apparatuses with various sizes and areas. With the growing popularity of portable electronic products, flexible displays such as electronic paper (e-paper), e-books (e-book), and so on have been gradually attractive by the customers on the market.

In general speaking, the e-paper and the e-book are based on electrophoretic display technique for the display purpose. Taking the e-book with black and white displayed colours only as an example, the display medium thereof mainly comprises a black electrophoretic liquid and white charged particles doped in the black electrophoretic liquid. After applying voltages on the medium, the white charged particles are driven to migrate so that each pixel respectively displays black colour, white colour or gray colour with a graylevel.

In the prior art, the electrophoretic display mostly utilizes light reflection of an external light source to achieve display purpose, while through driving the white charged particles doped in the electrophoretic liquid by applied voltages, each pixel can display with a required graylevel. For expanding the application of the electrophoretic display, a colorful filter film is fabricated on the display medium and the colorful filter film is fixed on the display medium through an adhesive layer. At the time, after the incident light is reflected by the white charged particles in the display medium, the colorful filter film displays out a colorful hue. However, the reflectivity of the white charged particles is not high enough (for example, lower than 60%). As a result, the hue and luminance displayed after the reflected light passes through the colorful filter film are not noticeable and satisfied.

### SUMMARY OF THE INVENTION

Accordingly, the invention is directed to an electrophoretic display film to reduce the conventional problems produced by low reflectivity of white charged particles.

The invention is also directed to an electrophoretic display apparatus able to produce better luminance and better hue quality.

The invention provides an electrophoretic display film, which includes a first protective film, a second protective film and a plurality of display media. The second protective film is opposite to the first protective film. The display media are disposed between the first protective film and the second protective film, in which each of the display media includes an electrophoretic liquid and a plurality of black charged particles and a plurality of charged particles with metallic gloss both distributed in the electrophoretic liquid.

In an embodiment of the present invention, the material of the above-mentioned first protective film includes poly-ethylene terephthalate (PET).

In an embodiment of the present invention, the material of the above-mentioned second protective film includes poly-ethylene terephthalate (PET).

In an embodiment of the present invention, each of the above-mentioned display media further includes a microcup structure disposed on the first protective film and joining the second protective film so as to pack the electrophoretic liquid, the black charged particles and the charged particles with metallic gloss in the microcup structure.

In an embodiment of the present invention, each of the above-mentioned charged particles with metallic gloss includes a silver particle, an aluminium particle or a magnesium particle.

In an embodiment of the present invention, the outer surface of each of the above-mentioned charged particles with metallic gloss is enclosed with a transparent resin.

In an embodiment of the present invention, each of the above-mentioned charged particles with metallic gloss is a white charged particle and the outer surface of the white charged particle is enclosed with a metallic dye or a metallic lacquer.

In an embodiment of the present invention, the diameter of each the above-mentioned charged particle with metallic gloss ranges between 10 nm and 20 μm.

The invention also provides an electrophoretic display apparatus, which includes a driving array substrate and an electrophoretic display film. The electrophoretic display film is disposed on the driving array substrate and includes a first protective film, a second protective film and a plurality of display media. The first protective film is located on the driving array substrate. The second protective film is opposite to the first protective film. The display media are disposed between the first protective film and the second protective film, in which each of the display media includes an electrophoretic liquid and a plurality of black charged particles and a plurality of charged particles with metallic gloss both distributed in the electrophoretic liquid.

In an embodiment of the present invention, the material of the above-mentioned first protective film includes poly-ethylene terephthalate (PET).

In an embodiment of the present invention, the material of the above-mentioned second protective film includes poly-ethylene terephthalate (PET).

In an embodiment of the present invention, each of the above-mentioned display media further includes a microcup structure disposed on the first protective film and joining the second protective film so as to pack the electrophoretic liquid, the black charged particles and the charged particles with metallic gloss in the microcup structure.

In an embodiment of the present invention, each of the above-mentioned charged particles with metallic gloss includes a silver particle, an aluminium particle or a magnesium particle.

In an embodiment of the present invention, each of the above-mentioned charged particles with metallic gloss is composed of a metallic particle and a transparent resin enclosing an outer surface of the metallic particle.

In an embodiment of the present invention, each of the above-mentioned charged particles with metallic gloss is composed of a white charged particle and a metallic dye or a metallic lacquer enclosing an outer surface of the white charged particle.

In an embodiment of the present invention, each of the above-mentioned charged particles with metallic gloss is composed of a metallic particle and a transparent resin enclosing an outer surface of the metallic particle.

In an embodiment of the present invention, each of the above-mentioned charged particles with metallic gloss is composed of a white charged particle and a metallic dye or a metallic lacquer enclosing an outer surface of the white charged particle.

In an embodiment of the present invention, the diameter of each the charged particle with metallic gloss ranges between 10 nm and 20 μm.

In an embodiment of the present invention, the above-mentioned electrophoretic display apparatus further includes a first transparent optical adhesive layer disposed between the driving array substrate and the first protective film of the electrophoretic display film, in which the electrophoretic display film is fixed on the driving array substrate through the first transparent optical adhesive layer.

In an embodiment of the present invention, the above-mentioned electrophoretic display apparatus further includes a color filter film disposed on the second protective film.

In an embodiment of the present invention, the above-mentioned electrophoretic display apparatus further includes a protective layer disposed on the color filter film.

In an embodiment of the present invention, the above-mentioned electrophoretic display apparatus further includes a second transparent optical adhesive layer disposed between the protective layer and the color filter film, in which the protective layer is fixed on the color filter film through the second transparent optical adhesive layer.

In an embodiment of the present invention, the above-mentioned driving array substrate is an active array substrate or a passive array substrate.

Based on the description above, since the display medium of the invention contains charged particles with metallic gloss therein, when the incident light enters the display medium, the charged particles with metallic gloss with better reflecting efficiency are able to effectively advance the displayed hue and luminance after the incident light is reflected.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A is a cross-sectional diagram of an electrophoretic display film according to an embodiment of the invention.

FIG. 1B is a cross-sectional diagram of a kind of white charged particle of FIG. 1A.

FIG. 1C is a cross-sectional diagram of another kind of white charged particle of FIG. 1A.

FIG. 1D is a cross-sectional diagram of yet another kind of white charged particle of FIG. 1A.

FIG. 2 is a cross-sectional diagram of an electrophoretic display film according to another embodiment of the invention.

FIG. 3 is a cross-sectional diagram of an electrophoretic display apparatus according to an embodiment of the invention.

FIG. 4 is a cross-sectional diagram of an electrophoretic display apparatus according to another embodiment of the invention.

### DESCRIPTION OF THE EMBODIMENTS

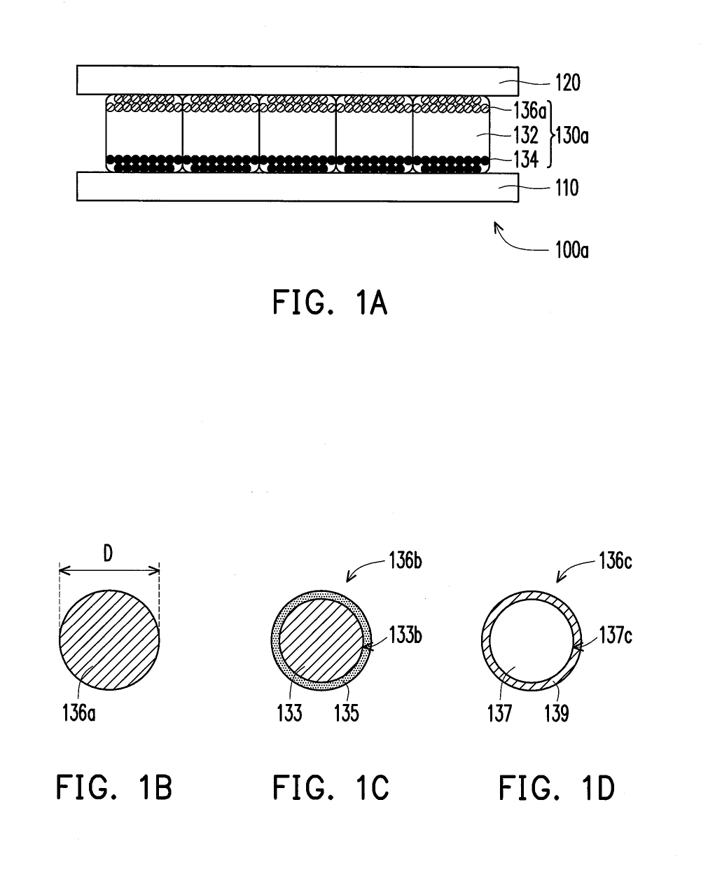

FIG. 1A is a cross-sectional diagram of an electrophoretic display film according to an embodiment of the invention and FIG. 1B is a cross-sectional diagram of a kind of white charged particle of FIG. 1A. Referring to FIGS. 1A and 1B, an electrophoretic display film 100a includes a first protective film 110, a second protective film 120 and a plurality of display media 130a. In more details, the second protective film 120 is opposite to the first protective film 110 and the materials of the first protective film 110 and the second protective film 120 are, for example, poly-ethylene terephthalate (PET). The display media 130a are disposed between the first protective film 110 and the second protective film 120, in which each of the display media 130a includes an electrophoretic liquid 132 and a plurality of black charged particles 134 and a plurality of charged particles with metallic gloss 136a both distributed in the electrophoretic liquid 132. The display medium 130a herein is, for example, a microcapsule structure.

Referring to FIG. 1B again, in the embodiment, each of the charged particles with metallic gloss 136a is, for example, a silver particle, an aluminium particle or a magnesium particle, and the diameter D of each charged particle with metallic gloss 136a ranges, for example, between 10 nm and 20 μm. However, the embodiment does not limit the structure form of the charged particles with metallic gloss. For example, referring to FIG. 1C, each of the charged particles with metallic gloss 136b comprises a metallic particle 133 and a transparent resin 135 enclosing an outer surface 133b of the metallic particle 133; or referring to FIG. 1D, each of charged particles with metallic gloss 136c comprises a white charged particle 137 and a metallic dye 139 or a metallic lacquer (not shown) enclosing an outer surface 137c of the white charged particle 137. The important herein is the structure must achieve an advanced reflection effect by design, and all the structures belong to the schemes adopted by the invention without departing from the claims of the invention.

Since the display medium 130a of the embodiment contains the charged particles with metallic gloss 136a (or 136b, 136c), the reflection efficiency of the charged particles with metallic gloss 136a (or 136b, 136c) is largely increased (for example, 90%) in comparison with the conventional white charged particles, which is able to advance the displayed hue (for example, black colour, white colour or gray colour with a graylevel) and luminance after the incident light (not shown) is reflected by the charged particles with metallic gloss 136a (or 136b, 136c) of the display medium 130a.

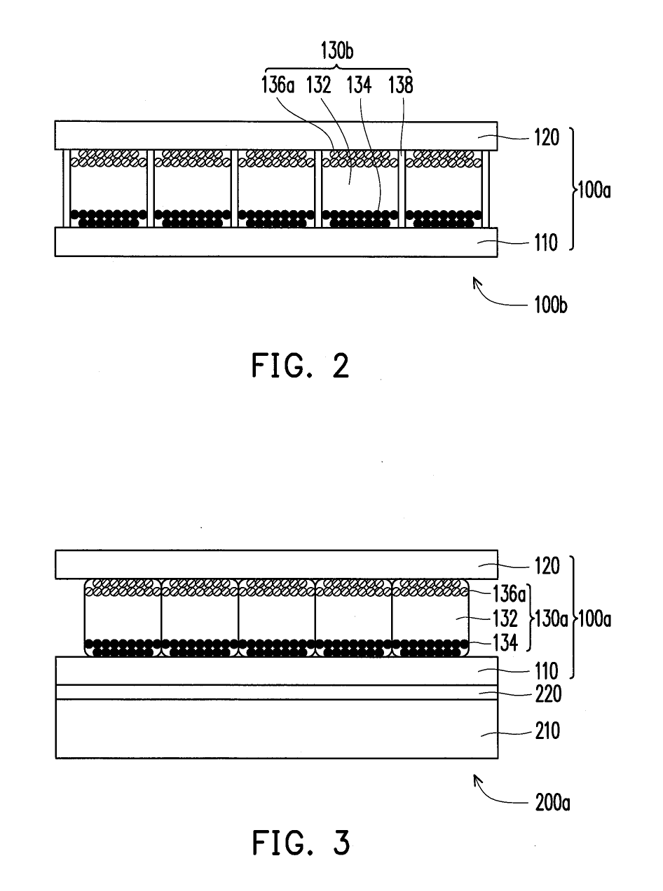

FIG. 2 is a cross-sectional diagram of an electrophoretic display film according to another embodiment of the invention. It should be noted the component notations and partial details of the structures hereinafter provided in the embodiments can be the same as or similar to the previous embodiment, wherein the same notations represent the same or similar components while the repeated same details are omitted, which can refer to the previous embodiment.

Referring to FIG. 2, the major difference of the electrophoretic display film 100b of the embodiment from the electrophoretic display film 100a of the previous embodiment rests in each display medium 130b of the embodiment further includes a microcup structure 138, which is disposed on the first protective film 110 and joins the second protective film 120 so as to pack the electrophoretic liquid 132, the black metallic particles 134 and the charged particles with metallic gloss 136a in the microcup structure 138, and the display medium 130b itself herein is, for example, a microcup structure.

FIG. 3 is a cross-sectional diagram of an electrophoretic display apparatus according to an embodiment of the invention. Referring to FIG. 3, the electrophoretic display apparatus 200a of the embodiment is an application of the electrophoretic display film 100a of the previous embodiment. In comparison with the previous embodiment, the electrophoretic display apparatus 200a of the embodiment further includes a driving array substrate 210 and a first transparent optical adhesive layer 220. The driving array substrate 210 herein is located under the electrophoretic display film 100a, and the electrophoretic display film 100a is fixed on the driving array substrate 210 through the first transparent optical adhesive layer 220 disposed between the driving array substrate 210 and the first protective film 110 of the electrophoretic display film 100a. The driving array substrate 210 herein is configured for driving the electrophoretic display film 100a, in which the driving array substrate 210 is, for example, an active array substrate or a passive array substrate.

Since the display medium 130a of the embodiment contains the charged particles with metallic gloss 136a, the reflection efficiency of the charged particles with metallic gloss 136a is largely increased (for example, 90%) in comparison with the conventional white charged particles, which is able to advance the displayed hue (for example, black colour, white colour or gray colour with a graylevel) and luminance after the incident light (not shown) is reflected by the charged particles with metallic gloss 136a of the display medium 130a. In other words, the electrophoretic display apparatus 200a of the embodiment can display with better luminance and better hue quality.

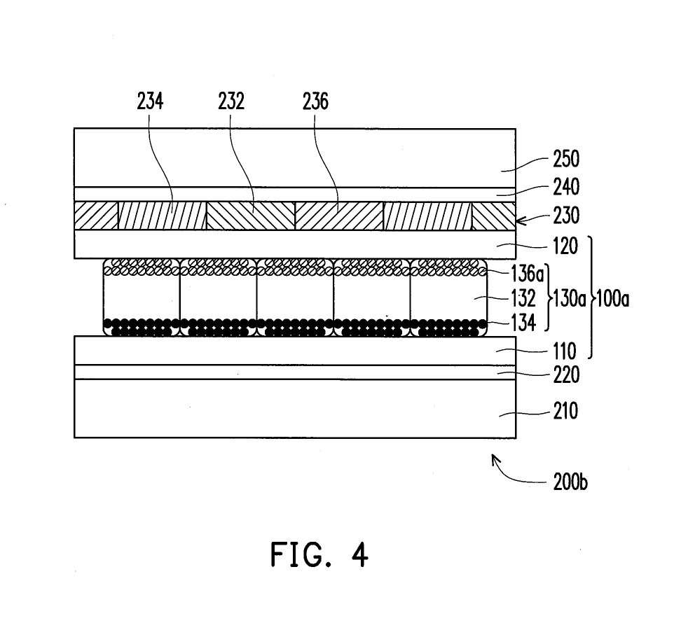

FIG. 4 is a cross-sectional diagram of an electrophoretic display apparatus according to another embodiment of the invention. It should be noted the component notations and partial details of the structures hereinafter provided in the embodiments can be the same as or similar to the previous embodiment, wherein the same notations represent the same or similar components while the repeated same details are omitted, which can refer to the previous embodiment.

Referring to FIG. 4, the major difference of the electrophoretic display apparatus 200b of the embodiment from the electrophoretic display apparatus 200a of the previous embodiment rests in the electrophoretic display apparatus 200b of the embodiment further includes a color filter film 230, a second transparent optical adhesive layer 240 and a protective layer 250. In more details, the color filter film 230 is disposed on the second protective film 120, the protective layer 250 is disposed on the color filter film 230, the second transparent optical adhesive layer 240 is disposed between the protective layer 250 and the color filter film 230, and the protective layer 250 is fixed on the color filter film 230 through the second transparent optical adhesive layer 240. The color filter film 230 herein comprises a plurality of red filter units 232, a plurality of blue filter units 234 and a plurality of green filter units 236, which the invention is not limited to.

Since the display medium 130a of the embodiment contains the charged particles with metallic gloss 136a, the reflection efficiency of the charged particles with metallic gloss 136a is largely increased (for example, 90%) in comparison with the conventional white charged particles, which is able to advance the displayed hue (for example, colourful hue) and luminance after the incident light (not shown) is reflected by the charged particles with metallic gloss 136a of the display medium 130a and then passes through the color filter film 230. In other words, the electrophoretic display apparatus 200b of the embodiment can display with better luminance and better hue quality.

In addition, in other unshown embodiments, the display medium can contain other kinds of charged particles with metallic gloss such as 136b and 136c of the previous embodiments, and people skilled in the art can chose the previous parts to achieve the desired technical effect according to the application requirements and referring to the previous embodiments.

In summary, since the display medium of the invention contains charged particles with metallic gloss therein, when the incident light enters the display medium, the charged particles with metallic gloss with better reflecting efficiency are able to effectively advance the displayed hue and luminance after the incident light is reflected. In short, the electrophoretic display apparatus employing the electrophoretic display film can display with better luminance and better hue quality (for example, black colour, white colour, gray colour with a graylevel or colourful hue).

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. An electrophoretic display film, comprising:
a first protective film;
a second protective film, opposite to the first protective film; and
a plurality of display media, disposed between the first protective film and the second protective film, wherein each of the display media comprises an electrophoretic liquid and a plurality of black charged particles and a plurality of charged particles with metallic gloss both distributed in the electrophoretic liquid.

2. The electrophoretic display film as claimed in claim 1, wherein material of the first protective film comprises poly-ethylene terephthalate (PET).

3. The electrophoretic display film as claimed in claim 1, wherein material of the second protective film comprises poly-ethylene terephthalate (PET).

4. The electrophoretic display film as claimed in claim 1, wherein each of the display media further comprises a microcup structure disposed on the first protective film and joining the second protective film so as to pack the electrophoretic liquid, the black charged particles and the charged particles with metallic gloss in the microcup structure.

5. The electrophoretic display film as claimed in claim 1, wherein each of the charged particles with metallic gloss comprises a silver particle, an aluminium particle or a magnesium particle.

6. The electrophoretic display film as claimed in claim 1, wherein each of the charged particles with metallic gloss is composed of a metallic particle and a transparent resin enclosing an outer surface of the metallic particle.

7. The electrophoretic display film as claimed in claim 1, wherein each of the charged particles with metallic gloss is composed of a white charged particle and a metallic dye or a metallic lacquer enclosing an outer surface of the white charged particle.

8. The electrophoretic display film as claimed in claim 1, wherein diameter of each the charged particle with metallic gloss ranges between 10 nm and 20 μm.

9. An electrophoretic display apparatus, comprising:
a driving array substrate; and
an electrophoretic display film, disposed on the driving array substrate and comprising:
a first protective film, located on the driving array substrate;
a second protective film, opposite to the first protective film; and
a plurality of display media, disposed between the first protective film and the second protective film, wherein each of the display media comprises an electrophoretic liquid and a plurality of black charged particles and a plurality of charged particles with metallic gloss both distributed in the electrophoretic liquid.

10. The electrophoretic display apparatus as claimed in claim 9, wherein material of the first protective film comprises poly-ethylene terephthalate (PET).

11. The electrophoretic display apparatus as claimed in claim 9, wherein material of the second protective film comprises poly-ethylene terephthalate (PET).

12. The electrophoretic display apparatus as claimed in claim 9, wherein each of the display media further comprises a microcup structure disposed on the first protective film and joining the second protective film so as to pack the electrophoretic liquid, the black charged particles and the charged particles with metallic gloss in the microcup structure.

13. The electrophoretic display apparatus as claimed in claim 9, wherein each of the charged particles with metallic gloss comprises a silver particle, an aluminium particle or a magnesium particle.

14. The electrophoretic display apparatus as claimed in claim 9, wherein each of the charged particles with metallic gloss is composed of a metallic particle and a transparent resin enclosing an outer surface of the metallic particle.

15. The electrophoretic display apparatus as claimed in claim 9, wherein each of the charged particles with metallic gloss is composed of a white charged particle and a metallic dye or a metallic lacquer enclosing an outer surface of the white charged particle.

16. The electrophoretic display apparatus as claimed in claim 9, wherein diameter of each the charged particle with metallic gloss ranges between 10 nm and 20 μm.

17. The electrophoretic display apparatus as claimed in claim 9, further comprising a first transparent optical adhesive layer disposed between the driving array substrate and the first protective film of the electrophoretic display film, wherein the electrophoretic display film is fixed on the driving array substrate through the first transparent optical adhesive layer.

18. The electrophoretic display apparatus as claimed in claim 9, further comprising a color filter film disposed on the second protective film.

19. The electrophoretic display apparatus as claimed in claim 18, further comprising a protective layer disposed on the color filter film.

20. The electrophoretic display apparatus as claimed in claim 19, further comprising a second transparent optical adhesive layer disposed between the protective layer and the color filter film, wherein the protective layer is fixed on the color filter film through the second transparent optical adhesive layer.

21. The electrophoretic display apparatus as claimed in claim 9, wherein the driving array substrate is an active array substrate or a passive array substrate.
